(19) United States
(12) Patent Application Publication
(10) Pub. No.: US 2014/0347319 A1
(43) Pub. Date: Nov. 27, 2014

(54) TOUCH PANEL

(71) Applicant: WINTEK CORPORATION, Taichung City (TW)

(72) Inventors: Tzu-Ling Lin, New Taipei City (TW); Kuo-Hsing Chen, New Taipei City (TW); Chen-Hao Su, Taichung City (TW); Cheng-Yen Yeh, Taichung City (TW); Yu-Ting Chen, Taoyuan County (TW); Chin-Chang Liu, Taichung City (TW); Kuo-Chang Su, Taichung City (TW)

(73) Assignee: WINTEK CORPORATION, Taichung City (TW)

(21) Appl. No.: 14/283,233

(22) Filed: May 21, 2014

(30) Foreign Application Priority Data
May 27, 2013 (TW) 102118635
Jul. 17, 2013 (CN) 201310300864.0

(51) Int. Cl. G06F 3/044

(52) U.S. Cl. CPC G06F 3/044
USPC 345/174

(57) ABSTRACT

A touch panel, having a center region and a peripheral region disposed on at least one side of the center region, includes a first electrode. The first electrode includes a plurality of first sub-electrodes and a plurality of second sub-electrode. The first sub-electrodes are disposed in the center region, and the second sub-electrodes are disposed on the peripheral region. A pattern density of the second sub-electrodes in the peripheral region is higher than a pattern density of the first sub-electrodes in the center region.

### BACKGROUND OF THE INVENTION

1. Field of the Invention

The present invention generally relates to a touch panel, and more particularly, to a touch panel including sub-electrodes having a higher pattern density in a peripheral region and sub-electrodes having a lower pattern density in a center region.

2. Description of the Prior Art

In recent years, touch sensing technologies have developed flourishingly. There are many diverse technologies of touch panel, such as the resistance touch technology, the capacitive touch technology and the optical touch technology which are the main touch technologies in use. The capacitive touch technology has become the mainstream touch technology for the high-end and the mid-end consumer electronics, because the capacitive touch panel has advantages such as high precision, multi-touch property, better endurance, and higher touch resolution. In the capacitive touch technology, sensing electrodes are used to detect the variations of electrical capacitances around a touch point, and feedback signals are transmitted via connecting lines, which interconnect all of the sensing electrodes along different axis directions to locate the touch points. In the conventional capacitive touch panel, some sub-electrodes in the peripheral region will be incomplete in shape because of cutting, and the amount of the sub-electrodes disposed adjacently to each sub-electrode in the peripheral region is less than that in the center region. Therefore, the coupled capacitance effect generated between the sub-electrodes in the peripheral region will be less than that in the center region. The touch identification performance in the peripheral region and the linearity of touch operations between the center region and the peripheral region will be influenced accordingly.

### SUMMARY OF THE INVENTION

It is one of the objectives of the present invention to provide a touch panel. A pattern density of sub-electrodes in a peripheral region are designed to be higher than a pattern density of sub-electrodes in a center region so as to enhance the touch identification performance in the peripheral region and the linearity of touch operations between the center region and the peripheral region.

To achieve the purposes described above, a preferred embodiment of the present invention provides a touch panel. The touch panel has a center region and a peripheral region disposed on at least one side of the center region. The touch panel includes a first electrode. The first electrode includes a plurality of first sub-electrodes and a plurality of second sub-electrodes. The first sub-electrodes are disposed in the center region. The second sub-electrodes are disposed in the peripheral region. A pattern density of the second sub-electrodes in the peripheral region is higher than a pattern density of the first sub-electrodes in the center region.

In the touch panel of the present invention, the pattern density of the sub-electrodes in the peripheral region are designed to be higher than the pattern density of the sub-electrodes in the center region, and the coupled capacitance effect generated between the sub-electrodes in the peripheral region may then become larger than or equal to the coupled capacitance effect generated between the sub-electrodes in the center region. The purposes of enhancing the touch identification performance in the peripheral region and improving the linearity of touch operations between the center region and the peripheral region may be achieved accordingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a touch panel according to a first preferred embodiment of the present invention.

FIG. 2 is a locally enlarged diagram of FIG. 1.

FIG. 3 is a schematic cross-sectional diagram taken along a line A-A′ in FIG. 2.

FIG. 4 is a schematic cross-sectional diagram taken along a line B-B′ in FIG. 2.

FIGS. 5-7 are schematic diagrams illustrating local parts of a sub-electrode in the touch panel of the present invention.

FIG. 8 is a schematic diagram illustrating a touch panel according to a second preferred embodiment of the present invention.

FIG. 9 is a schematic cross-sectional diagram taken along a line C-C′ in FIG. 8.

FIG. 10 is a schematic cross-sectional diagram taken along a line D-D′ in FIG. 8.

FIG. 11 is a schematic diagram illustrating a touch panel according to a third preferred embodiment of the present invention.

FIG. 12 is a schematic cross-sectional diagram taken along a line E-E′ in FIG. 11.

FIG. 13 is a schematic diagram illustrating a touch panel according to a fourth preferred embodiment of the present invention.

FIG. 14 is a schematic diagram illustrating a touch panel according to a fifth preferred embodiment of the present invention.

FIG. 15 is a schematic diagram illustrating a touch panel according to a sixth preferred embodiment of the present invention.

FIG. 16 is a schematic diagram illustrating a touch panel according to a seventh preferred embodiment of the present invention.

FIG. 17 is a schematic diagram illustrating a touch panel according to an eighth preferred embodiment of the present invention.

FIG. 18 is a schematic diagram illustrating a touch panel according to a ninth preferred embodiment of the present invention.

FIG. 19 is a schematic diagram illustrating a touch panel according to a tenth preferred embodiment of the present invention.

FIG. 20 is a schematic diagram illustrating a touch panel according to an eleventh preferred embodiment of the present invention.

FIG. 21 is a schematic diagram illustrating a touch panel according to a twelfth preferred embodiment of the present invention.

FIG. 22 is a schematic diagram illustrating a touch panel according to a thirteenth preferred embodiment of the present invention.

FIG. 23 is a schematic diagram illustrating a touch panel according to a fourteenth preferred embodiment of the present invention.

FIG. 24 is a schematic diagram illustrating a touch panel according to a fifteenth preferred embodiment of the present invention.

FIG. 25 is a schematic diagram illustrating a touch panel according to a sixteenth preferred embodiment of the present invention.

### DETAILED DESCRIPTION

To provide a better understanding of the present invention to the skilled users in the technology of the present invention, preferred embodiments will be detailed as follows. The preferred embodiments of the present invention are illustrated in the accompanying drawings with numbered elements to elaborate the contents and effects to be achieved.

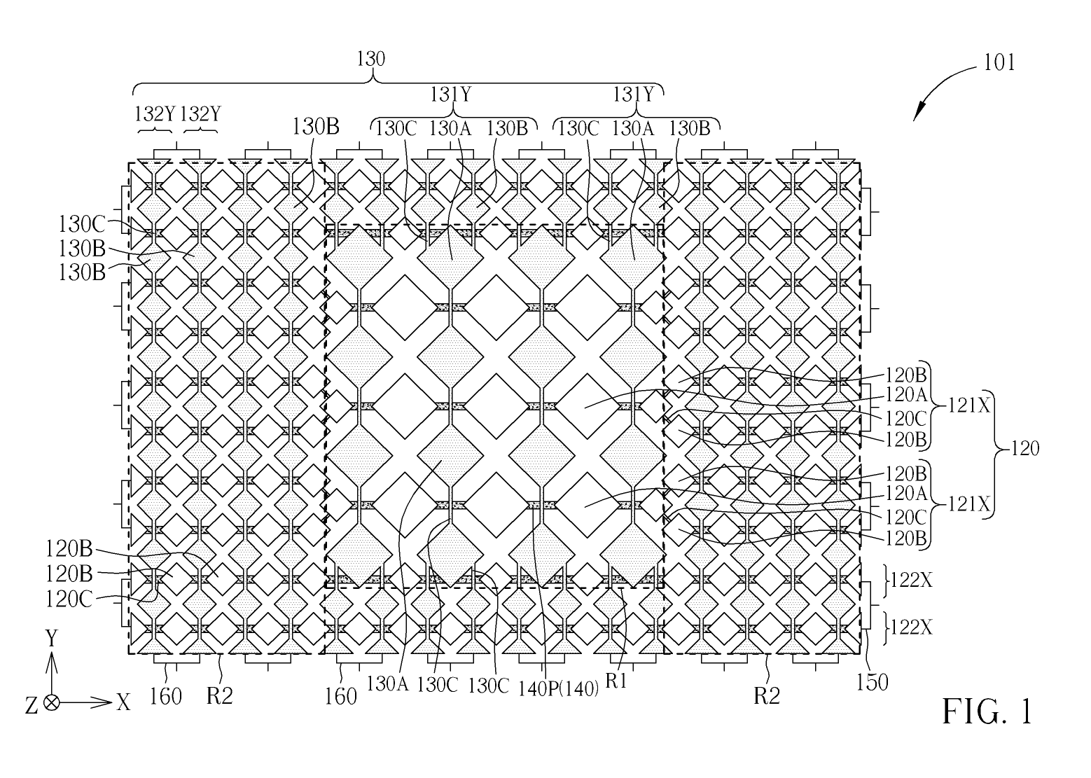

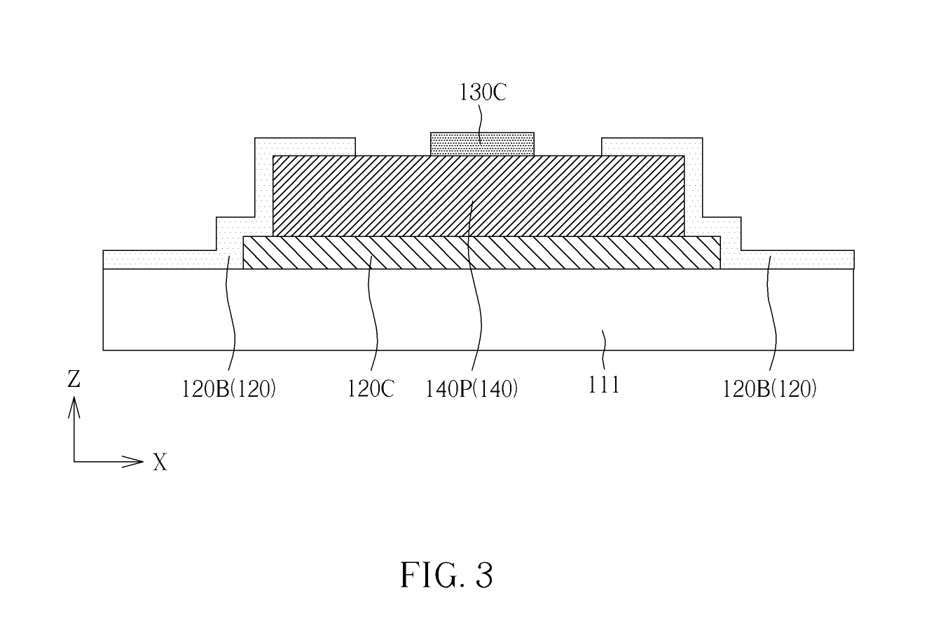

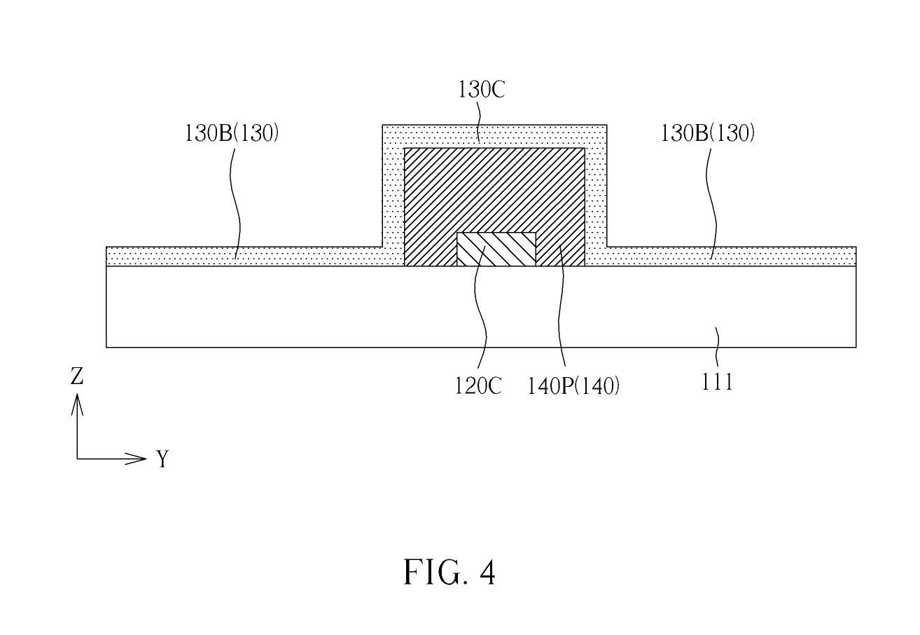

As shown in FIGS. 1-4, a touch panel 101 of the first preferred embodiment of the present invention has a center region R1 and a peripheral region R2. The peripheral region R2 is disposed on at least one side of the center region R1. In this embodiment, the peripheral region R2 is located at two side of the center region R1, but the present invention is not limited to this. In other embodiments of the present invention, the peripheral region R2 may surround the center region R1 or just be disposed adjacent to partial side of the center region R1. The touch panel 101 includes a first substrate 111, a first electrode 120 and a second electrode 130. The first electrode 120 and the second electrode 130 are disposed on the first substrate 111. The first substrate 111 may include a glass substrate, a rigid cover substrate (cover lens), a plastic substrate, a flexible cover substrate, a flexible plastic substrate such as a plastic film, a thin glass substrate such as a glass film, or a substrate of a display device. A decoration layer (not shown) may be disposed on at least one side of the above-mentioned cover substrate, and the decoration layer may be disposed on a part of the peripheral region R2 or on the entire peripheral region R2. The substrate of the display device mentioned above may include a color filter substrate of a liquid crystal display device or an encapsulation substrate of an organic light emitting display device. The first electrode 120 includes a plurality of first sub-electrodes 120A and a plurality of second sub-electrodes 120B. The first sub-electrodes 120A are disposed in the center region R1, and the second sub-electrodes 120B are disposed in the peripheral region R2. The second electrode 130 is not electrically connected to the first electrode 120 directly. In other words, the second electrode 130 is electrically insulated from the first electrode 120. The second electrode 130 includes a plurality of third sub-electrodes 130A and a plurality of fourth sub-electrodes 130B. The third sub-electrodes 130A are disposed in the center region R1, and the fourth sub-electrodes 130B are disposed in the peripheral region R2. A location of each third sub-electrode 130A in the center region R1 is different from a location of each first sub-electrode 120A, and each third sub-electrode 130A is electrically insulated from each first sub-electrode 120A. A location of each fourth sub-electrode 130B in the peripheral region R2 is different from a location of each second sub-electrode 120B, and each fourth sub-electrode 130B is electrically insulated from each second sub-electrode 120B. In this embodiment, each first sub-electrode 120A and each third sub-electrode 130A are alternately disposed in the center region R1, and each second sub-electrode 120B and each fourth sub-electrode 130B are alternately disposed in the peripheral region R2, but not limited thereto. Within an identical unit area, such as an area of 1 cm×2 cm or an area of 3 cm×3 cm, a pattern density of the second sub-electrodes 120B in the peripheral region R2 is higher than a pattern density of the first sub-electrodes 120A in the center region R1, and a pattern density of the fourth sub-electrodes 130B in the peripheral region R2 is higher than a pattern density of the third sub-electrodes 130A in the center region R1. The pattern density in this invention is defined as the amount of each specific pattern within a unit area. When a driving signal is applied to the first electrode 120 or the second electrode 130, fringe electrical capacitance formed between the second sub-electrodes 120B and the fourth sub-electrodes 130B within a unit area in the peripheral region R2 may be larger than or equal to fringe electrical capacitance formed between the first sub-electrodes 120A and the third sub-electrodes 130A within an identical unit area in the center region R1 under the design of the sub-electrodes mentioned above. In this embodiment, an area of each first sub-electrode 120A is larger than an area of each second sub-electrode 120B preferably, and an area of each third sub-electrode 130A is larger than an area of each fourth sub-electrode 130B preferably, but not limited thereto. For example, the first sub-electrode 120A and the third electrode 130A may be a rhombus electrode pad respectively and have substantially identical patterns. The second sub-electrode 120B may be a rhombus electrode pad with an area equal to a quarter of the first sub-electrode 120A, and the fourth sub-electrode 130B may be a rhombus electrode pad with an area equal to a quarter of the third sub-electrode 130A, but not limited thereto. When a touch object touches the touch the center region R1 and the peripheral region R2 by an identical touch area respectively, fringe electrical capacitance formed between the second sub-electrodes 120B and the fourth sub-electrodes 130B in the peripheral region R2 may be larger than or equal to fringe electrical capacitance formed between the first sub-electrodes 120A and the third sub-electrodes 130A in the center region R1 because the pattern density of the second sub-electrodes 120B is higher than the pattern density of the first sub-electrodes 120A within an identical unit area in the center region R1, and the pattern density of the fourth sub-electrodes 130B is higher than the pattern density of the third sub-electrodes 130A within an identical unit area in the center region R1. Therefore, even if some of the second sub-electrodes 120B and some of the fourth sub-electrodes 130B may be incomplete in shape because of cutting at the edge of the touch panel 101, the electrical capacitance effect generated in the peripheral region R2 may still be similar to the electrical capacitance effect generated in the center region R1. The touch identification performance in the peripheral region R2 may be enhanced and the linearity of touch operations in the peripheral region R2 may be improved accordingly. The linearity of touch operations in the peripheral region R2 may then become similar to the linearity of touch operations in the center region R1. It is worth noting that the linearity mentioned above is defined as a similarity between calculated touch points and actual touch points on the touch panel. In other words, the linearity may be defined as a deviation condition between an actual output average curve and a perfect straight line. A better linearity stands for better touch positioning accuracy. When the linearity in the center region R1 is similar to the linearity in the peripheral region R2, the consistency of the touch positioning performance may be improved, and additional compensation calculations for insufficient edge linearity will not be required.

More specifically, as shown in FIGS. 1-4, the touch panel 101 in this embodiment may include a plurality of first axis electrodes 121X, a plurality of first axis electrodes 122X, a plurality of second axis electrodes 131Y and a plurality of second axis electrodes 132Y. The first axis electrodes 121X and the first axis electrodes 122X extend along a row direction X respectively. The second axis electrodes 131Y and the second axis electrodes 132Y extend along a column direction Y respectively. Additionally, the touch panel 101 may include a plurality of first connection lines 120C and a plurality of second connection lines 130C. The first connection lines 120C is used to electrically connect the first sub-electrodes 120A or/and the second sub-electrodes 120B disposed adjacently to each other along the row direction X. The second connection lines 130C is used to electrically connect the third sub-electrodes 130A or/and the fourth sub-electrodes 130B disposed adjacently to each other along the column direction Y. In other words, each of the first axis electrodes 121X is composed of the first sub-electrodes 120A, the second sub-electrodes 120B and the first connection lines 120C disposed adjacently to one another along the row direction X. Each of the first axis electrodes 122X is composed of the second sub-electrodes 120B and the first connection lines 120C disposed adjacently to one another along the row direction X. Each of the second axis electrodes 131Y is composed of the third sub-electrodes 130A, the fourth sub-electrodes 130B and the second connection lines 130C disposed adjacently to one another along the column direction Y. Each of the second axis electrodes 132Y is composed of the fourth sub-electrodes 130B and the second connection lines 130C disposed adjacently to one another along the column direction Y. In each of the first axis electrodes 121X, each of the first sub-electrodes 120A is disposed adjacently to and electrically connected to at least one of the first sub-electrodes 120A or one of the second sub-electrodes 120B along the row direction X, and at least one of the first sub-electrodes 120A and at least a part of the second sub-electrodes 120B are electrically connected in parallel. In each of the second axis electrodes 131Y, each of the third sub-electrodes 130A is disposed adjacently to and electrically connected to at least one of the third sub-electrodes 130A or one of the fourth sub-electrodes 130B along the column direction Y, and at least one of the third sub-electrodes 130A and at least a part of the fourth sub-electrodes 130B are electrically connected in parallel. In other words, the first sub-electrodes 120A and the second sub-electrodes 120B are electrically connected to one another along the row direction X via the first connection lines 130C, and the third sub-electrodes 130A and the fourth sub-electrodes 130B are electrically connected to one another along the column direction Y via the second connection lines 130C. It is worth noting that the first axis electrodes 121X and the first axis electrodes 122X are touch signal driving electrodes, and the second axis electrodes 131Y and the second axis electrodes 132Y are touch signal receiving electrodes preferably so as to perform a mutual capacitive touch sensing operation, but not limited thereto. In other preferred embodiments of the present invention, the first axis electrodes 121X and the first axis electrodes 122X may be touch signal receiving electrodes, and the second axis electrodes 131Y and the second axis electrodes 132Y may be touch signal driving electrodes so as to perform the mutual capacitive touch sensing operation. Additionally, in this embodiment, adjacent second sub-electrodes 120B in different rows may be electrically connected to one another via a first trace 150, and adjacent fourth sub-electrodes 130B in different columns may be electrically connected to one another via a second trace 160 so as to reduce the amount of the required channels in the touch signal process unit (not shown), but not limited thereto.

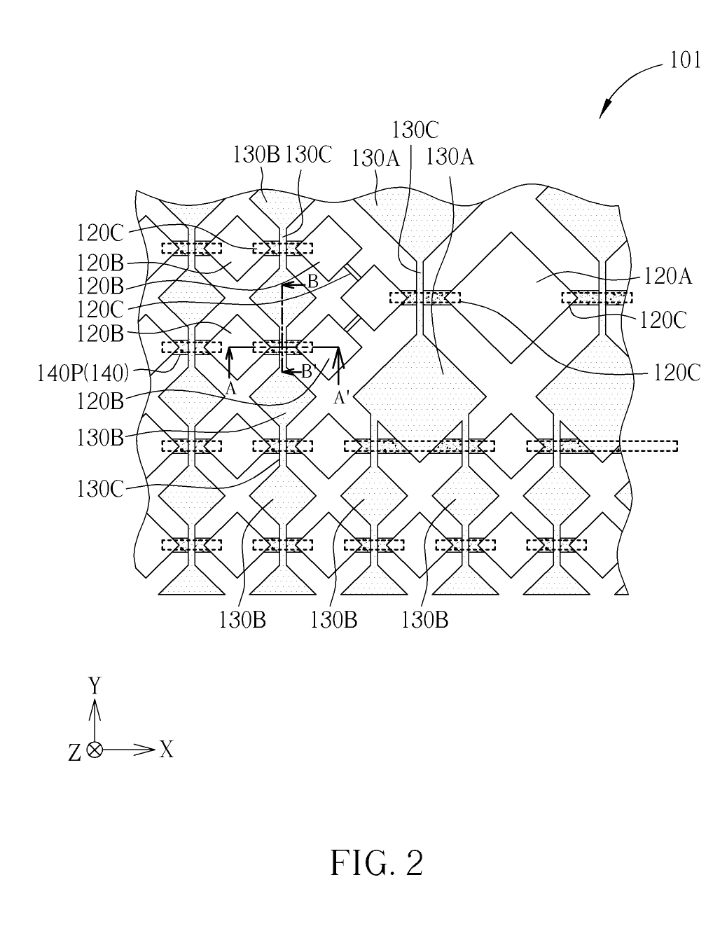

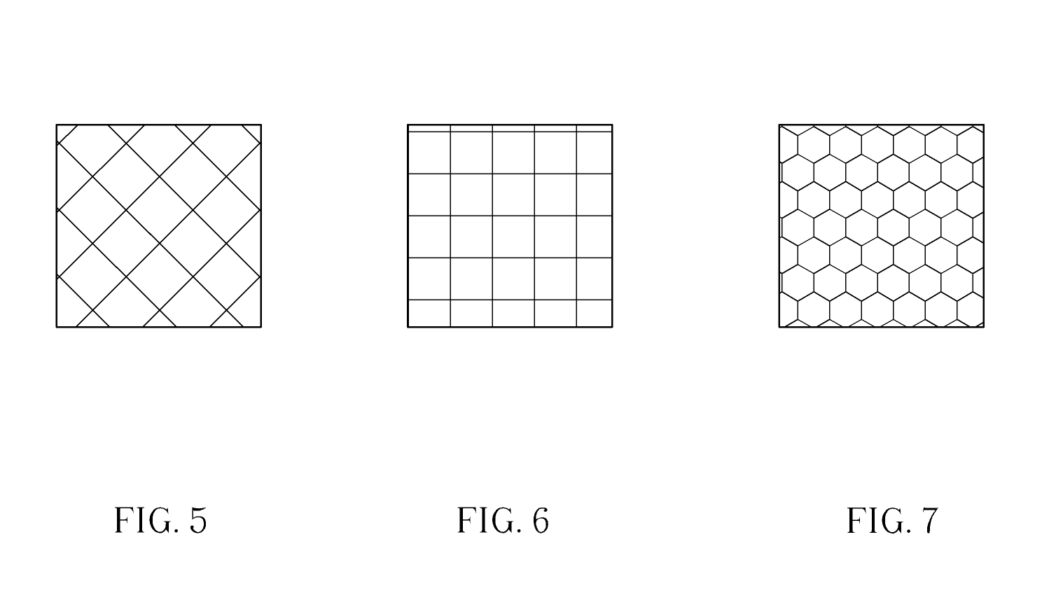

In this embodiment, the touch panel 101 may further include an insulation layer 140 disposed between each first connection line 120C and each second connection line 130C so as to electrically insulate the first connection lines 120C from the second connection lines 130C. The first electrode 120, the second electrode 130, the first connection lines 120C, the second connection lines 130C and the insulation layer 140 are disposed on the first substrate 111, and the first connection lines 120C is disposed between the insulation layer 140 and the first substrate 111. The insulation layer 140 at least partially exposes the first connection lines 120C along a vertical projection direction Z perpendicular to the first substrate 111, and the first sub-electrodes 120A and the second sub-electrodes 120B may then touch the first connection lines 120C uncovered by the insulation layer 140 for forming electrical connections. The insulation layer 140 in this embodiment may include a plurality of insulation blocks 140P disposed between each first connection line 120C and each second connection line 130C respectively, but not limited thereto. In other preferred embodiments of the present invention, an insulation layer with one complete surface may be used to cover the first connection lines 120C and contact holes may be disposed in the insulation layer for partially exposing the first connection lines 120C, and the corresponding first sub-electrodes 120A or the second sub-electrodes 120B may then contact the first connection lines 120C and be electrically connected to the first connection lines 120C. In this embodiment, the first sub-electrodes 120A, the second sub-electrodes 120B, the third sub-electrodes 130A and the fourth sub-electrodes 130B may preferably include a transparent conductive material or metal mesh. For example, as shown in FIGS. 5-7, the metal mesh may include geometric patterns in identical or different shapes and sizes disposed in a stack configuration, such as rhombus in FIG. 5, square or rectangle in FIG. 6, and hexagon in FIG. 7. However, the metal mesh in the present invention is not limited to the shapes described in FIGS. 5-7, and metal mesh in other regular or irregular shapes may also be applied in the present invention. For example, sinusoidal metal mesh pattern or other metal mesh patterns may be used in the present invention. The metal mesh may be a single layer or a multiple layer structure including different materials in a stack configuration. A line width of the metal mesh is preferably less than 10 micrometers (not shown). The transparent conductive material mentioned above may include indium tin oxide (ITO), indium zinc oxide (IZO), aluminum zinc oxide (AZO), or other appropriate transparent conductive materials. The above mentioned examples of the metal mesh, the metal material and the transparent conductive material may be applied in all of the embodiments in the present invention. It is worth noting that, as shown in FIGS. 2-4, the first connection lines 120C and the second connection lines 130C may include transparent conductive materials or metal conductive materials preferably. For example, the second connection lines 130C, the third sub-electrodes 130A and the fourth sub-electrodes 130B in this embodiment may be formed simultaneously by one identical material such as a transparent conductive material preferably so as to simplify the related manufacturing processes, but not limited thereto.

In this embodiment, the second sub-electrodes 120B and the fourth sub-electrodes 130B in relatively smaller sizes are disposed in the peripheral region R2, and the first sub-electrodes 120A and the third sub-electrodes 130A in relatively large sizes are disposed in the center region R1. Compared with the conventional sub-electrode design employing the sub-electrodes in one relatively small or relatively large size, the performance related to electrical capacitance or/and electrical resistance in this invention is more balanced, and some design problems caused by extreme electrical properties may be avoided accordingly.

The following description will detail the different embodiments of the present invention. To simplify the description, identical components in each of the following embodiments are marked with identical symbols. For making it easier to understand the differences between the embodiments, the following description will detail the dissimilarities among different embodiments and the identical features will not be redundantly described.

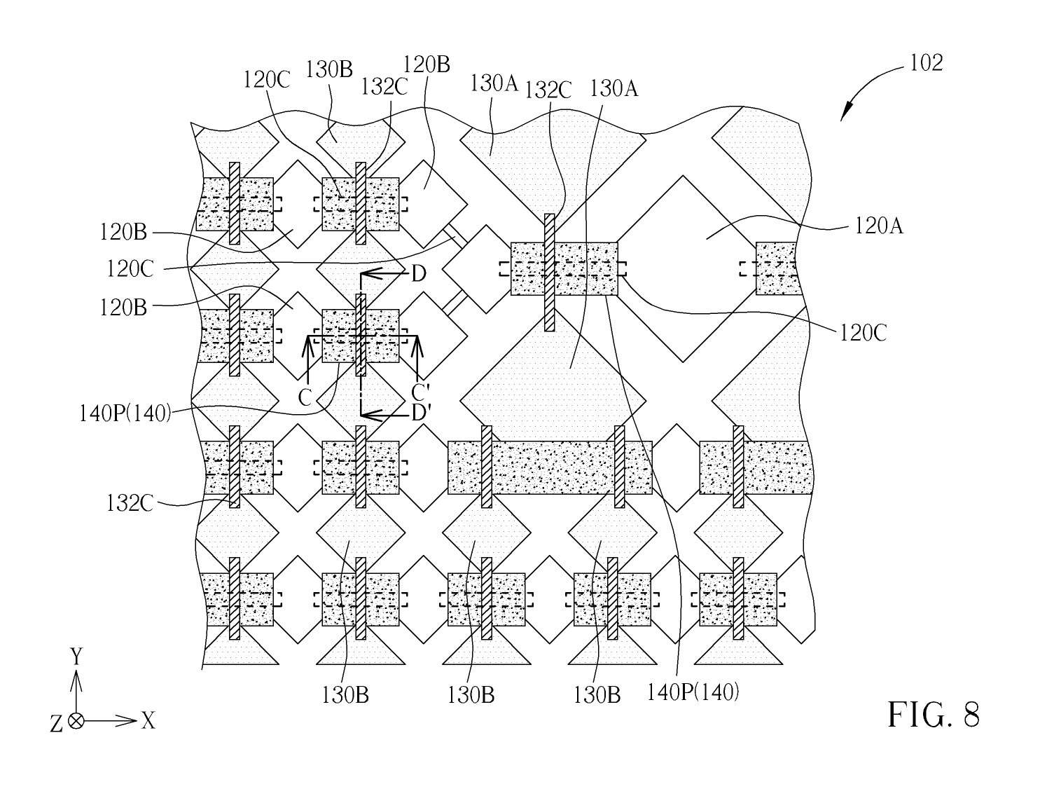

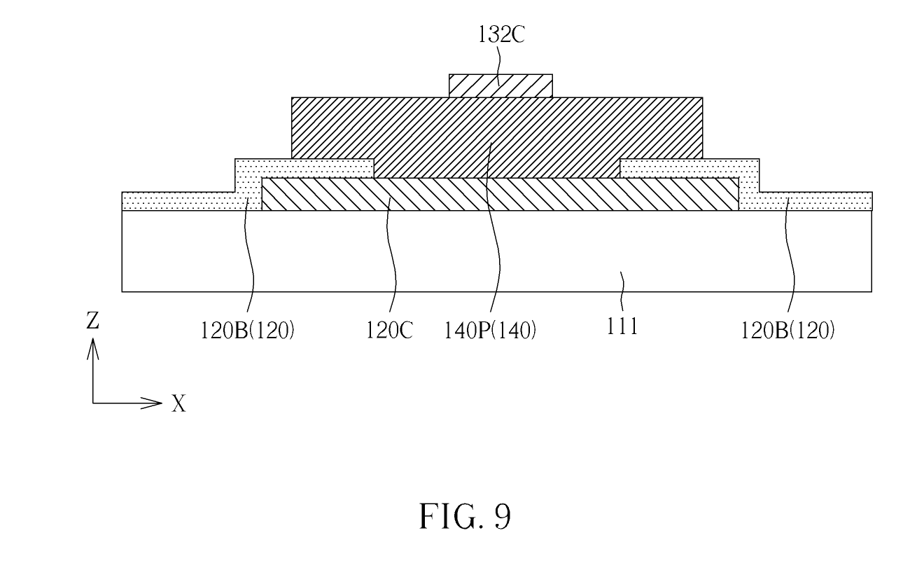

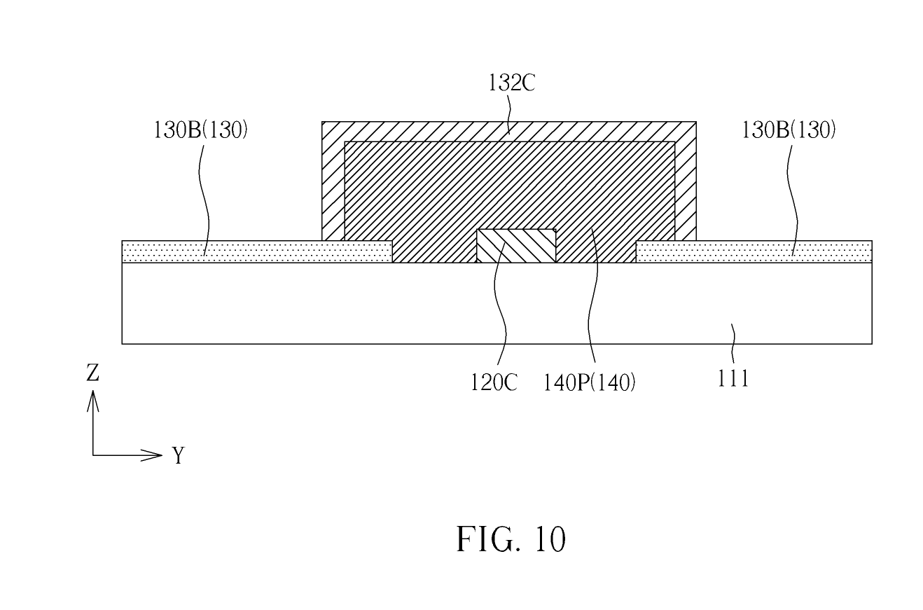

As shown in FIGS. 8-10, a touch panel 102 is provided in the second preferred embodiment of the present invention. The difference between the touch panel 102 in this embodiment and the touch panel in the first preferred embodiment mentioned above is that the touch panel 102 further includes a plurality of second connection lines 132C. The second connection lines 132C are used to electrically connect the third sub-electrodes 130A or/and the fourth sub-electrodes 130B disposed adjacently to each other along the column direction Y. The second connection lines 132C in this embodiment are preferably formed by a process different from the process of manufacturing the third sub-electrodes 130A and the fourth sub-electrodes 130B. For example, the third sub-electrodes 130A and the fourth sub-electrodes 130B are made of transparent conductive materials with high transparency preferably, and the second connection lines 132C are made of metal conductive materials with low electrical resistivity so as to lower the total resistance. Additionally, the insulation layer 140 in this embodiment partially covers the first sub-electrodes 120A, the second sub-electrodes 120B, the third sub-electrodes 130A and the fourth sub-electrodes 130B so as to avoid interference issues between different touch signals. Apart from the second connection lines 132C in the touch panel 102 of this embodiment, the allocations and the material properties of other components and the touch signal driving method in this embodiment are similar to those of the first preferred embodiment and will not be redundantly described.

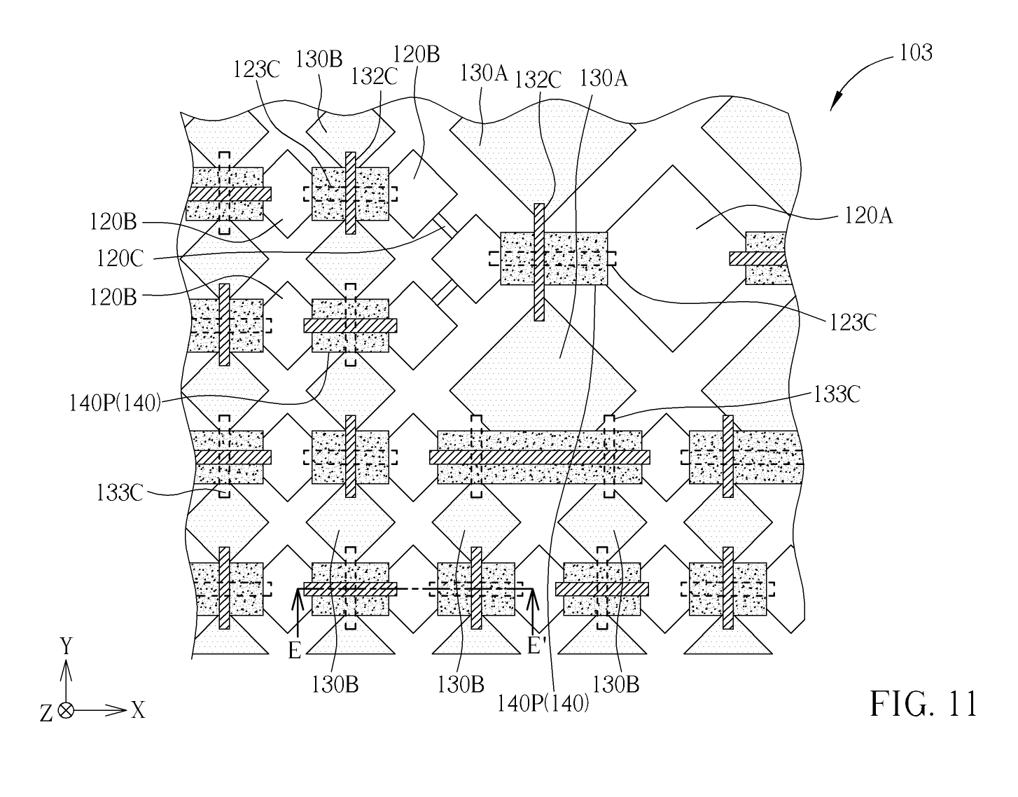

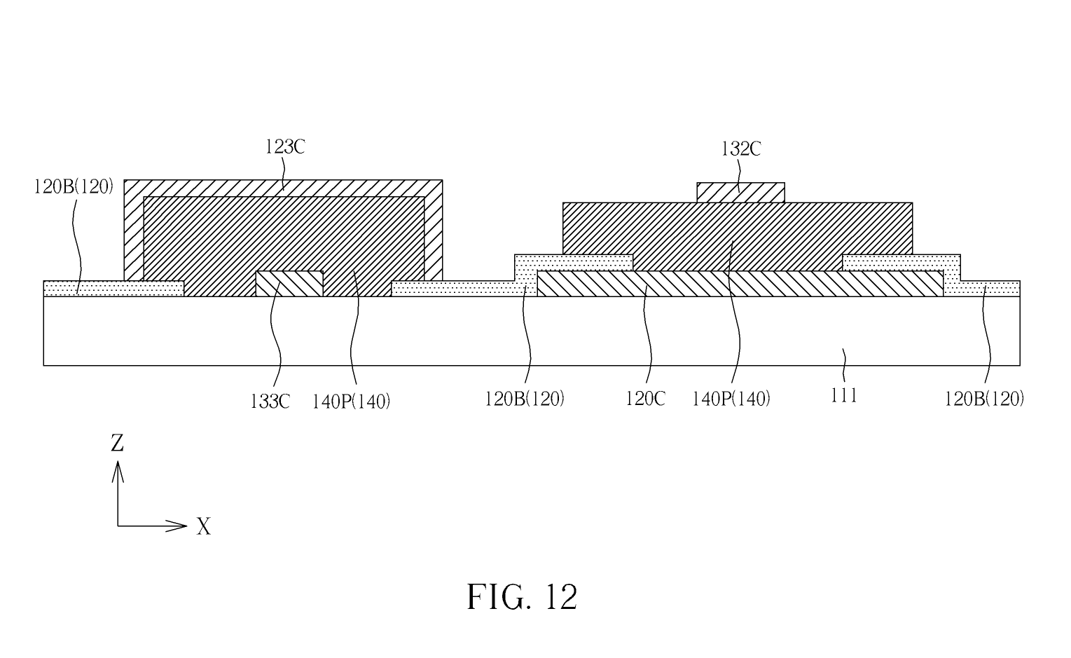

As shown in FIG. 11 and FIG. 12, a touch panel 103 is provided in the third preferred embodiment of the present invention. The difference between the touch panel 103 in this embodiment and the touch panel in the second preferred embodiment mentioned above is that the touch panel 103 further includes a plurality of first connection lines 123C and a plurality of second connection lines 133C. The first connection lines 123C are used to electrically connect the first sub-electrodes 120A or/and the second sub-electrodes 120B disposed adjacently to each other along the row direction X, and the second connection lines 133C are used to electrically connect the third sub-electrodes 130A or/and the fourth sub-electrodes 130B disposed adjacently to each other along the column direction Y. The second connection lines 133C are disposed between the insulation layer 140 and the first substrate 111. The first connection lines 120C and the second connection lines 133C may be made of an identical material and formed by an identical process. The first connection lines 123C and the second connection lines 133C may be made of an identical material and formed by an identical process. The first connection lines 123C and the second connection lines 132C may be made of an identical material and formed by different processes so as to reduce the influence of problems occurred in one specific process, and the total manufacturing yield may be enhanced accordingly.

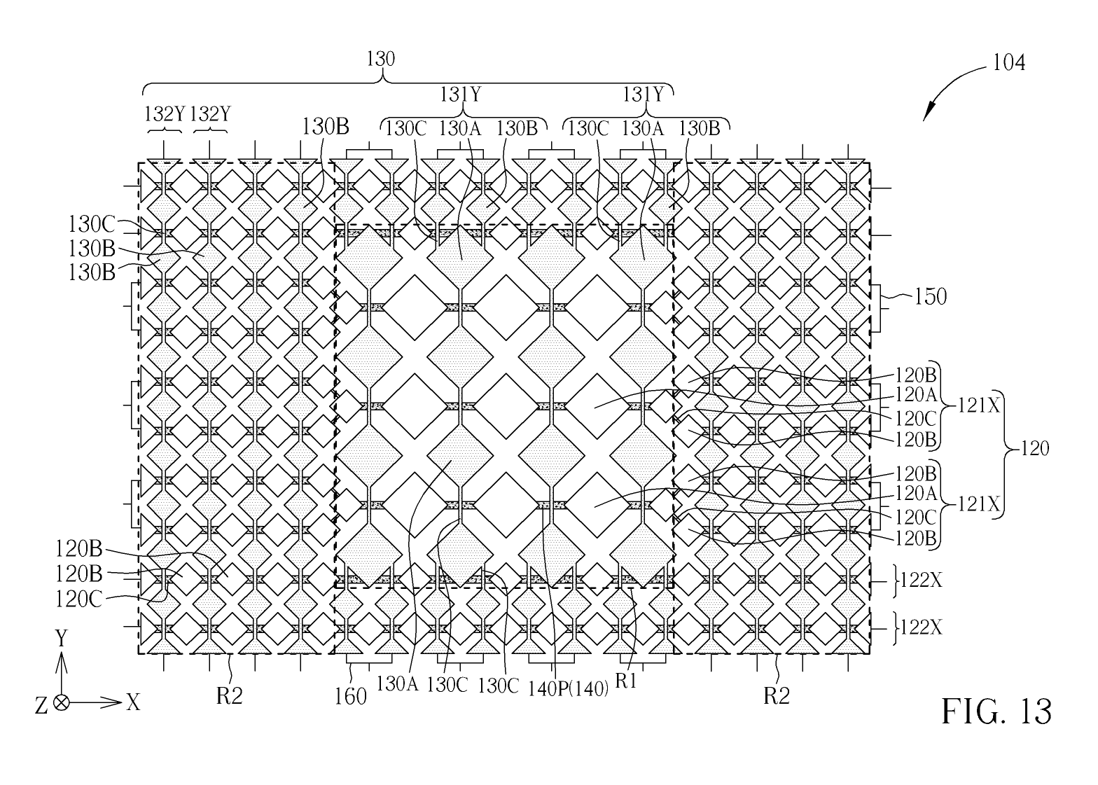

As shown in FIG. 13, a touch panel 104 is provided in the fourth preferred embodiment of the present invention. The difference between the touch panel 104 in this embodiment and the touch panel in the first preferred embodiment mentioned above is that, in the touch panel 104, the first axis electrodes 122X are electrically insulated from one another, and the second axis electrodes 132Y are electrically insulated from one another so as to increase the touch sensing resolution in the peripheral region R2.

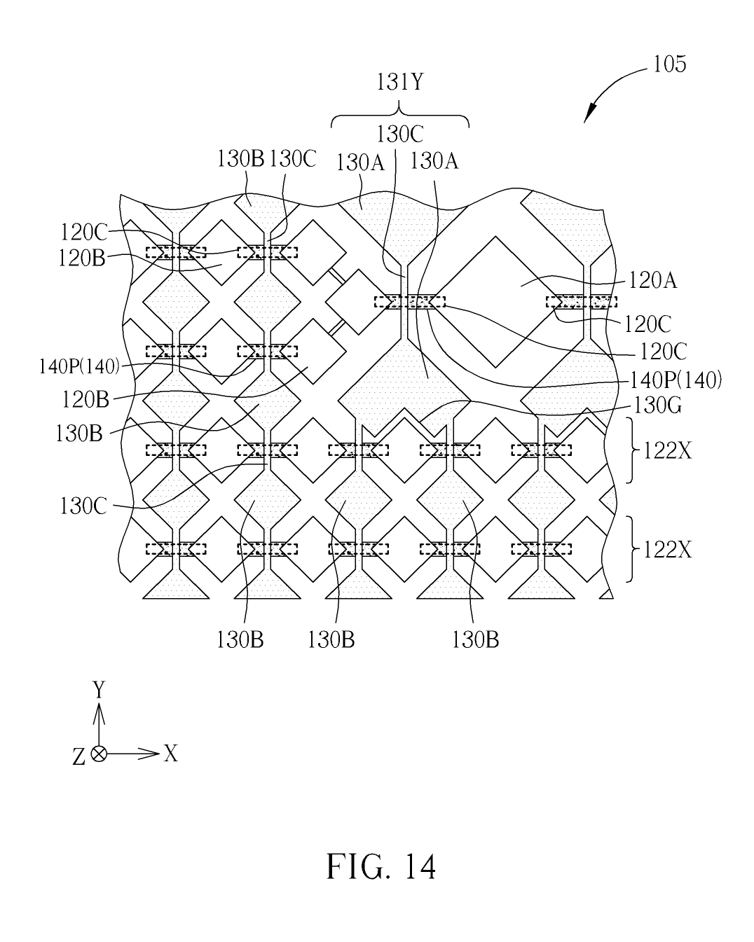

As shown in FIG. 14, a touch panel 105 is provided in the fifth preferred embodiment of the present invention. The difference between the touch panel 105 in this embodiment and the touch panel in the first preferred embodiment mentioned above is that, in the touch panel 105, at least one of the third sub-electrodes 130A includes a notch 130G surrounding the second sub-electrode 120B adjacent to the third sub-electrode 130A so as to avoid affecting the alignment of the second subs-electrodes 120 along the row direction at the cross region of the first axis electrode 122X and the second axis electrode 131Y.

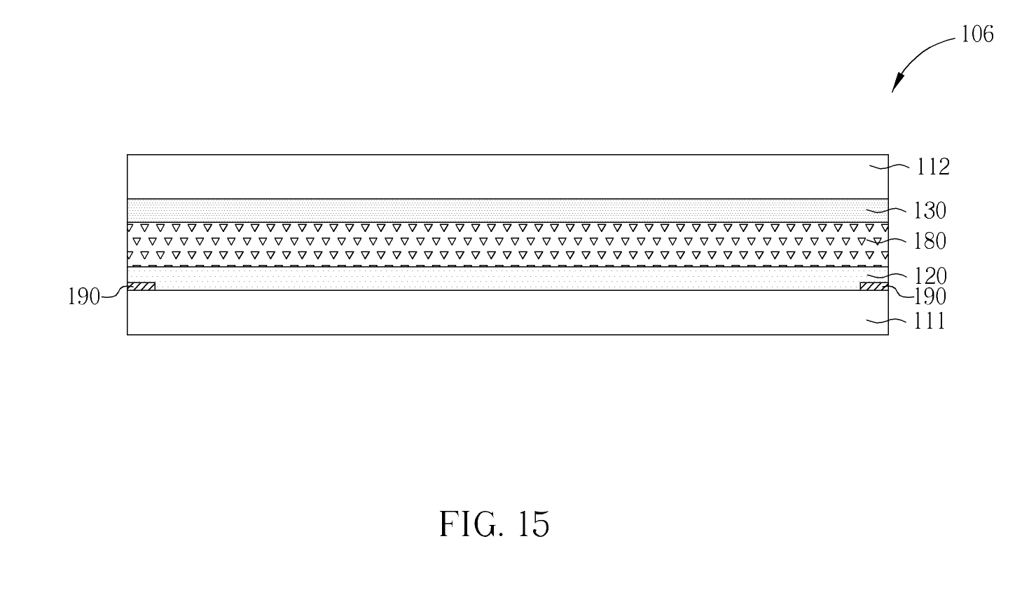

As shown in FIG. 15, a touch panel 106 is provided in the sixth preferred embodiment of the present invention. The difference between the touch panel 106 in this embodiment and the touch panel in the first preferred embodiment mentioned above is that the touch panel 106 further includes a second substrate 112 and an adhesion layer 180. The second substrate 112 is disposed correspondingly to the first substrate 111. At least one of the first substrate and the second substrate may include a rigid substrate or a flexible substrate. For example, at least one of the first substrate and the second substrate may include a glass substrate, a rigid cover substrate, a plastic substrate, a flexible cover substrate, a flexible plastic substrate such as a plastic film, a thin glass substrate such as a glass film, or a substrate of a display device. A decoration layer 190 is disposed on at least one side of the above-mentioned cover substrate, and the substrate of the display device mentioned above may include a color filter substrate of a liquid crystal display device or an encapsulation substrate of an organic light emitting display device. For instance, as shown in FIG. 15, when the first substrate 111 is a cover substrate with the decoration layer 190 disposed thereon, the corresponding second substrate 112 preferably is a glass substrate, a plastic substrate, a flexible plastic substrate such as a plastic film, a thin glass substrate such as a glass film, or a substrate of a display device, but the present invention is not limited to this. In other embodiments of the present invention, the first substrate 111 and the second substrate 112 may be made of an identical material or made of different materials, or substrates with other functions may also be employed to be the first substrate 111 or/and the second substrate 112. The above-mentioned glass substrate, the substrate of the display device and the encapsulation substrate of the organic light emitting display device may be a tempered glass treated by chemical or physical strengthening processes. The rigid cover substrate may be a transparent tempered glass treated by chemical or physical strengthening processes or a transparent plastic substrate with high rigidity which is hardly bent and with transparency higher than 85%. The above-mentioned substrates may be applied to all embodiments of the present invention. In this embodiment, the first electrode 120 and the second electrode 130 are disposed on different substrates preferably. The first electrode 120 may be disposed on the first substrate 111, the second electrode 130 may be disposed on the second substrate 112, and the adhesion layer 180 may be used to combine the first substrate 111 and the second substrate 112, but not limited thereto. It is worth noting that the design of disposing the first substrate 111 and the second substrate 112 on different substrates may also be applied to the above-mentioned embodiments and the subsequent embodiments according to different design considerations.

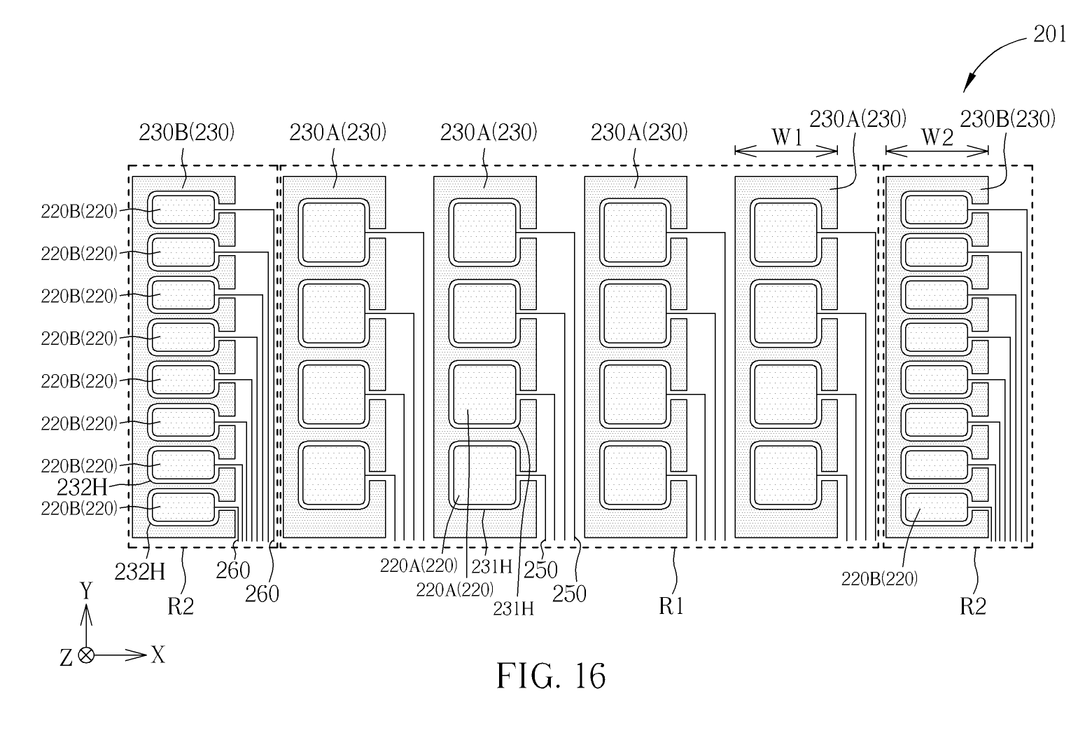

As shown in FIG. 16, a touch panel 201 is provided in the seventh preferred embodiment of the present invention. The touch panel 201 has the center region R1 and the peripheral region R2. The peripheral region R2 in this embodiment is located at two side of the center region R1, but not limited thereto. The touch panel 201 includes a first electrode 220 and a second electrode 230. The first electrode 220 includes a plurality of first sub-electrodes 220A and a plurality of second sub-electrodes 220B. The first sub-electrodes 220A are disposed in the center region R1, and the second sub-electrodes 220B are disposed in the peripheral region R2. The second electrode 230 includes a plurality of third sub-electrodes 230A and a plurality of fourth sub-electrodes 230B. The third sub-electrodes 230A are disposed in the center region R1, and the fourth sub-electrodes 230B are disposed in the peripheral region R2. Each of the third sub-electrodes 230A includes a plurality of first hollow regions 231H aligned along the column direction Y, and each of the fourth sub-electrodes 230B includes a plurality of second hollow region 232H aligned along the column direction Y. The first sub-electrodes 220A are disposed in the first hollow regions 231H, and the second sub-electrodes 220B are disposed in the second hollow regions 232H. Dummy electrodes (not shown) may be disposed in each first hollow regions 231H between the first sub-electrodes 220A and the second sub-electrodes 220B, and the dummy electrodes may also be disposed in the second hollow regions 232H between the third sub-electrodes 230A and the fourth sub-electrodes 230B. The dummy electrodes may be electrically insulated from the first sub-electrodes 220A, the second sub-electrodes 220B, the third sub-electrodes 230A and the fourth sub-electrodes 230B. In other words, the first sub-electrodes 220A, the second sub-electrodes 220B, the third sub-electrodes 230A, the fourth sub-electrodes 230B and the dummy electrodes do not overlap with one another along the vertical projective direction Z, bridge structures are not required in the touch panel 201, and the purposes of process reduction and structure simplification may be achieved accordingly. In this embodiment, a width W1 of each third sub-electrode 230A along the row direction X is substantially equal to a width W2 of each fourth sub-electrode 230B along the row direction X, but not limited thereto. Additionally, the touch panel 201 may further include a plurality of first traces 250 and a plurality of second traces 260. Each of the first traces 250 is electrically connected to one of the first sub-electrodes 220A, and each of the second traces 260 is electrically connected to one of the second sub-electrodes 220B.

It is worth noting that a pattern density of the second sub-electrodes 220B in the peripheral region R2 is higher than a pattern density of the first sub-electrodes 220A in the center region R1, and fringe electrical capacitance formed between the second sub-electrodes 220B and the fourth sub-electrodes 230B in the peripheral region R2 may then be larger than fringe electrical capacitance formed between the first sub-electrodes 220A and the third sub-electrodes 230A in the center region R1. In this embodiment, an area of each first sub-electrode 220A is larger than an area of each second sub-electrode 220B preferably, but not limited thereto. When a touch object such as a finger touches the touch the center region R1 and the peripheral region R2 in the touch panel 201 by an identical touch area respectively, fringe electrical capacitance formed between the second sub-electrodes 220B and the fourth sub-electrodes 230B in the peripheral region R2 may be larger than or equal to fringe electrical capacitance formed between the first sub-electrodes 220A and the third sub-electrodes 230A in the center region R1 because the pattern density of the second sub-electrodes 220B in the peripheral region R2 is higher than the pattern density of the first sub-electrodes 220A in the center region R1. The touch identification performance in the peripheral region R2 may be enhanced and the linearity of touch operations in the peripheral region R2 may be improved accordingly. The linearity of touch operations in the peripheral region R2 may then become similar to the linearity of touch operations in the center region R1.

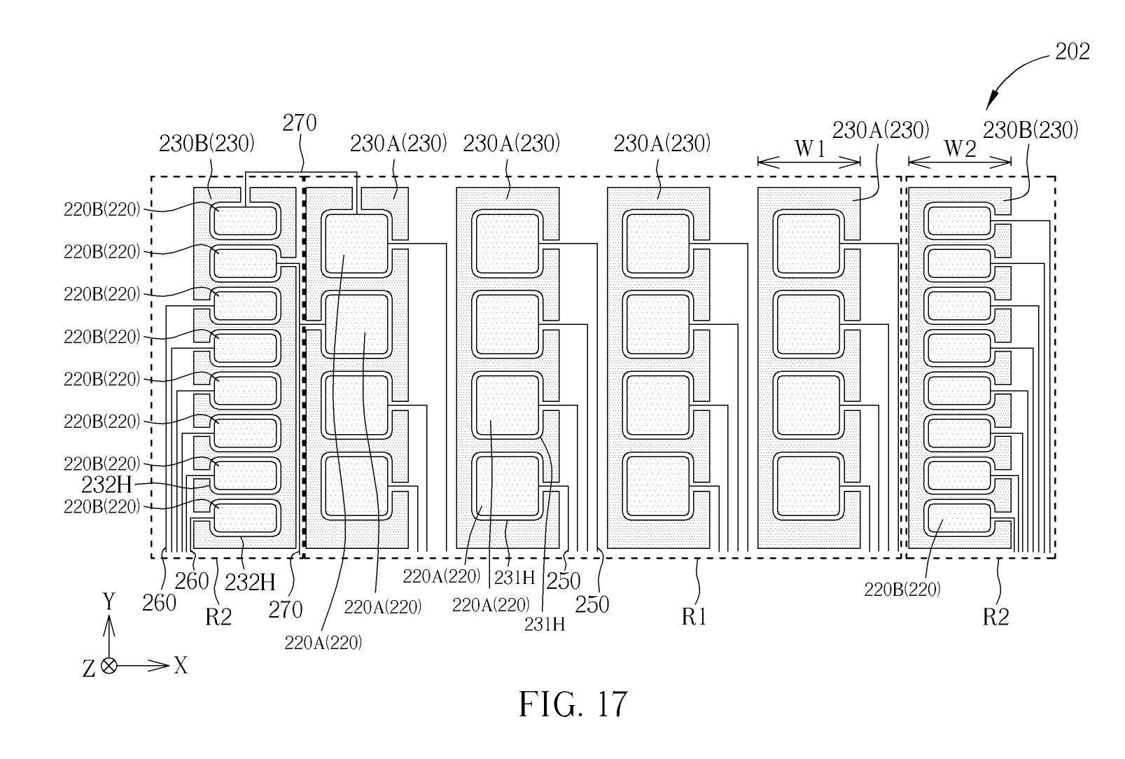

As shown in FIG. 17, a touch panel 202 is provided in the eighth preferred embodiment of the present invention. The difference between the touch panel 202 in this embodiment and the touch panel in the seventh preferred embodiment mentioned above is that the touch panel 202 further includes at least one third trace 270. The third trace 270 is electrically connected to at least one of the first sub-electrodes 220A and at least one of the second sub-electrodes 220B so as to reduce the amount of the required channels in the touch signal process unit (not shown), but not limited thereto. Apart from the third trace 270 in the touch panel 202 of this embodiment, the allocations and the material properties of other components and the touch signal driving method in this embodiment are similar to those of the seventh preferred embodiment and will not be redundantly described. In addition, the third trace 270 in this embodiment is not limited to be disposed at one side of the center region R2 or at two sides of the center region R2.

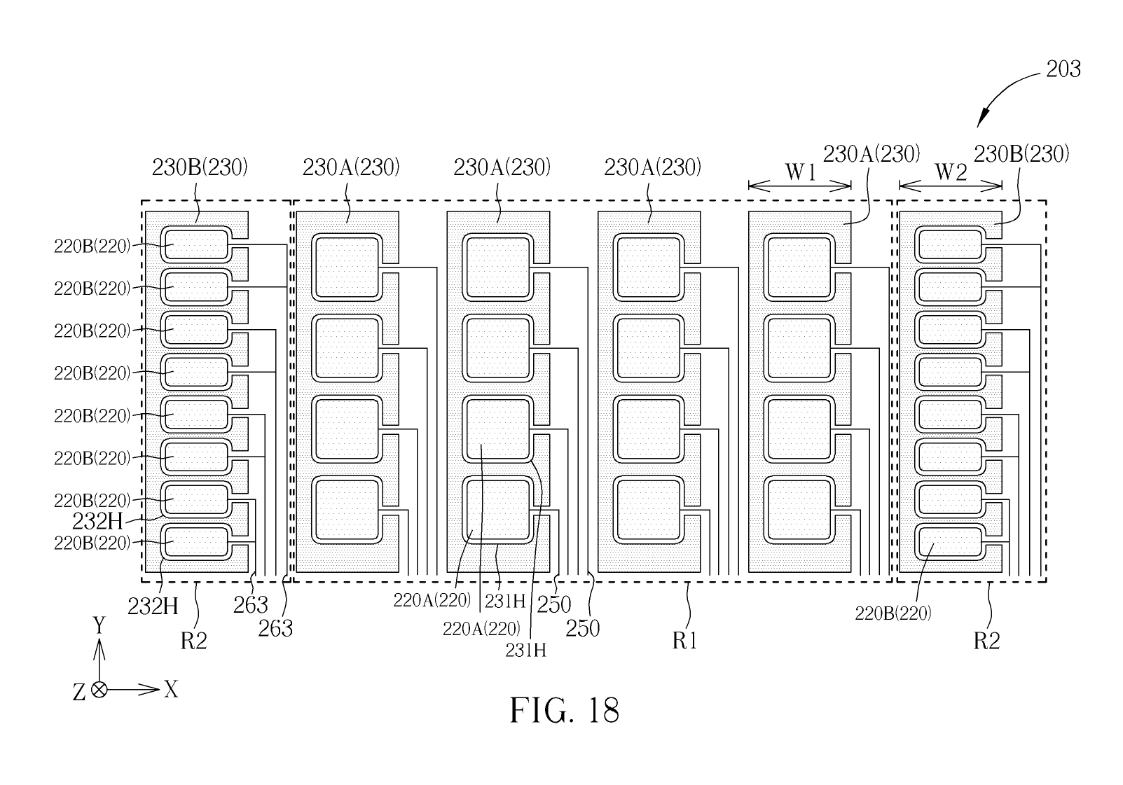

As shown in FIG. 18, a touch panel 203 is provided in the ninth preferred embodiment of the present invention. The difference between the touch panel 203 in this embodiment and the touch panel in the seventh preferred embodiment mentioned above is that the touch panel 203 includes a plurality of second traces 263, and each of the second traces 263 is electrically connected to two of the second sub-electrodes 220B so as to reduce the amount of the required channels in the touch signal process unit (not shown), but not limited thereto.

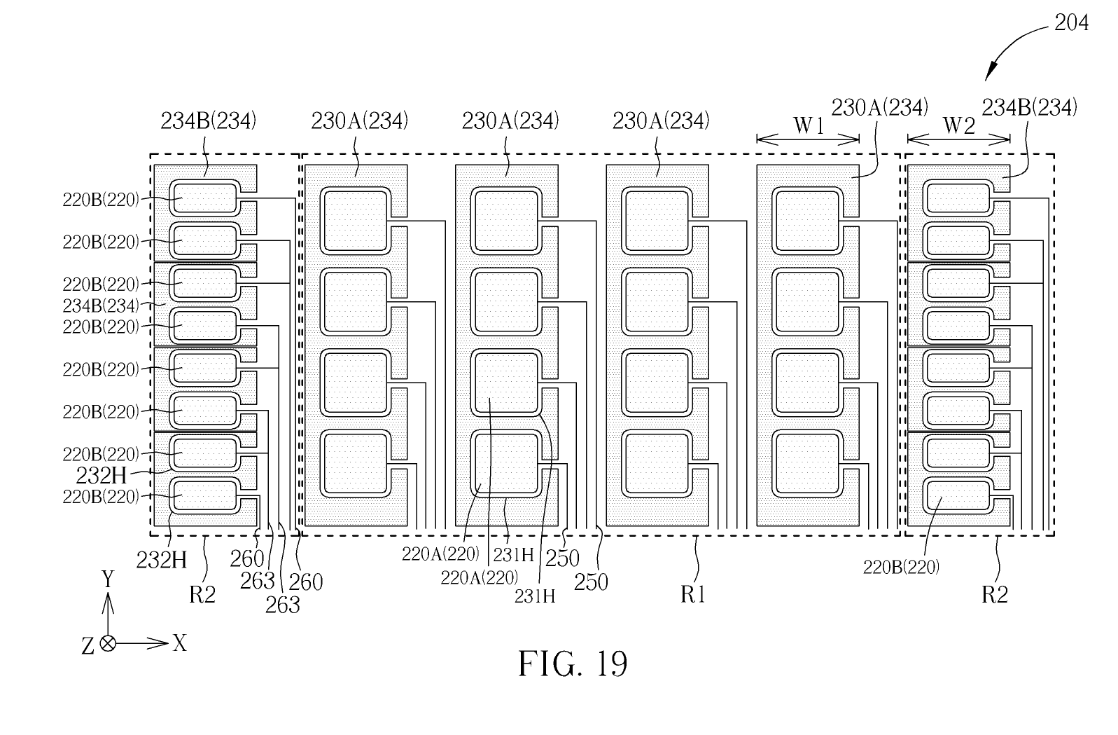

As shown in FIG. 19, a touch panel 204 is provided in the tenth preferred embodiment of the present invention. The difference between the touch panel 204 in this embodiment and the touch panel in the seventh preferred embodiment mentioned above is that the touch panel 204 includes the first electrode 220 and a second electrode 234. The second electrode 234 includes a plurality of third sub-electrodes 230A and a plurality of fourth sub-electrodes 234B. The fourth sub-electrodes 234B are disposed in the peripheral region R2 and aligned along the column direction Y in the peripheral region R2. Additionally, the touch panel 204 further includes a plurality of second traces 263. Each of the second traces 263 us electrically connected to two second sub-electrodes 220B corresponding to different fourth sub-electrodes 263B, and the amount of the traces may then be reduced without influencing the touch sensing resolution.

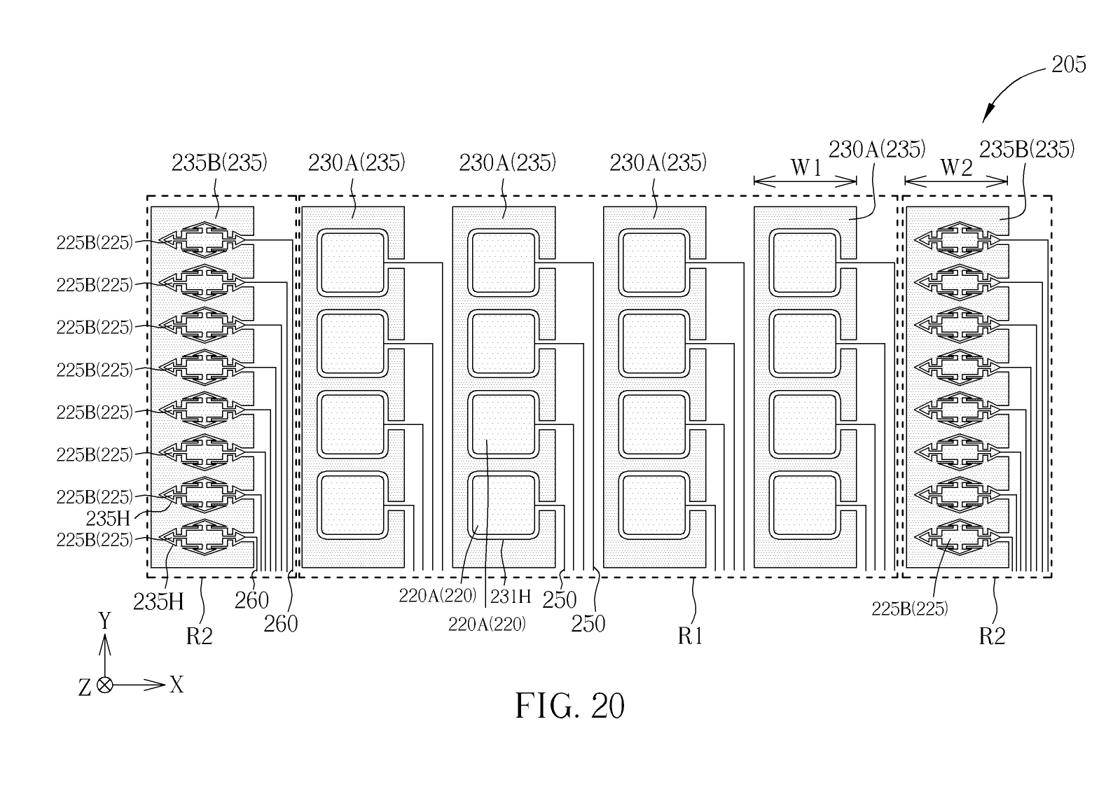

As shown in FIG. 20, a touch panel 205 is provided in the eleventh preferred embodiment of the present invention. The difference between the touch panel 205 in this embodiment and the touch panel in the seventh preferred embodiment mentioned above is that the touch panel 205 includes a first electrode 225 and a second electrode 235. The first electrode 225 includes a plurality of first sub-electrodes 220A and a plurality of second sub-electrodes 225B. The second sub-electrodes 225B are disposed in the peripheral region R2. The second electrode 235 includes a plurality of third sub-electrodes 230A and a plurality of fourth sub-electrodes 235B. The fourth sub-electrodes 235B are disposed in the peripheral region R2. Each of the fourth sub-electrodes 235B includes a plurality of second hollow regions 235H aligned along the column direction Y, and the second sub-electrodes 225B are disposed in the second hollow region 235H. It is worth noting that the shape of the second sub-electrode 225B is different from the shape of the first sub-electrode 220A. The shape of the second sub-electrode 225B may be modified to be a regular or irregular shape for increasing the fringe electrical capacitance formed between the second sub-electrodes 225B and the fourth sub-electrodes 235B in the peripheral region R2. The fringe electrical capacitance formed between the second sub-electrodes 225B and the fourth sub-electrodes 235B in the peripheral region R2 may then be larger than the fringe electrical capacitance formed between the first sub-electrodes 220A and the third sub-electrodes 230A in the center region R1. In other words, the shapes of the second sub-electrodes 225B are modified to increase the area between the second sub-electrodes 225B and the fourth sub-electrodes 235B so as to enhance the fringe electrical capacitance formed between the second sub-electrodes 225B and the fourth sub-electrodes 235B.

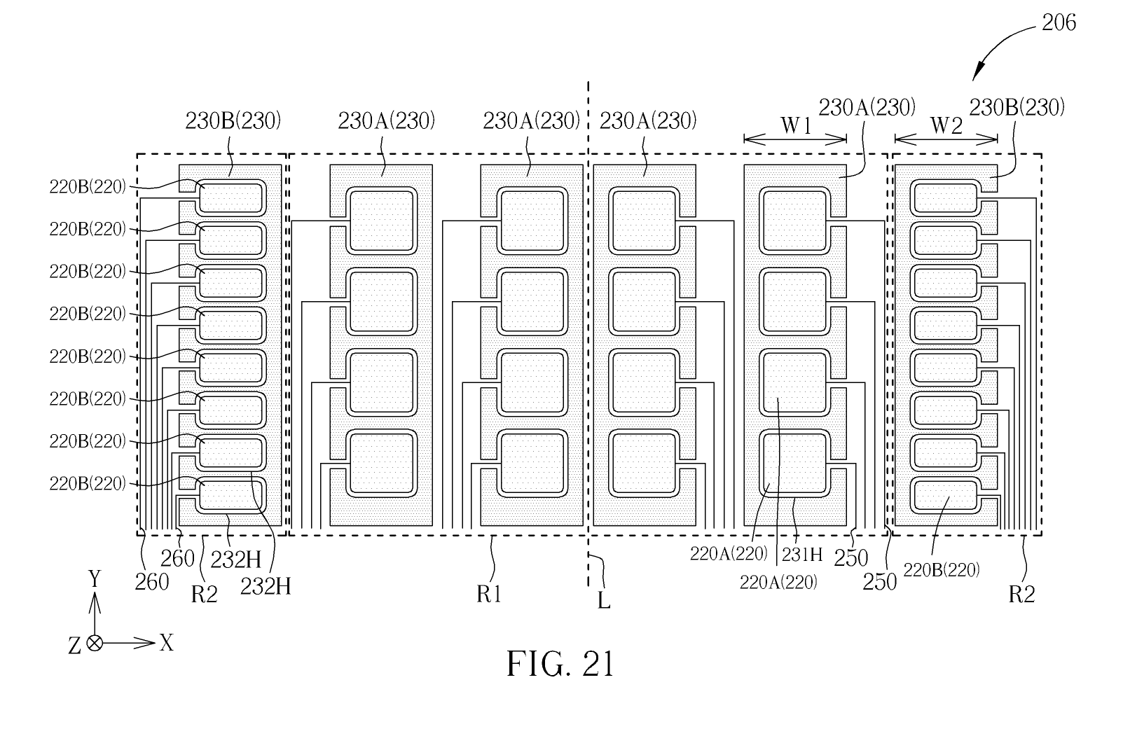

As shown in FIG. 21, a touch panel 206 is provided in the twelfth preferred embodiment of the present invention. The difference between the touch panel 206 in this embodiment and the touch panel in the seventh preferred embodiment mentioned above is that, in the touch panel 206, the first sub-electrodes 220A, the third sub-electrodes 230A and the first traces 250 have a shape with mirror symmetry symmetrical to a straight symmetry line L. The second sub-electrodes 220B, the fourth sub-electrode 230B and the second traces 260 have a shape with mirror symmetry symmetrical to the straight symmetry line L. Additionally, the first traces 250 and the second traces 260 are disposed on positions more far from the straight symmetry line L, compared with the corresponding first sub-electrodes 220A and the corresponding second sub-electrodes 220B.

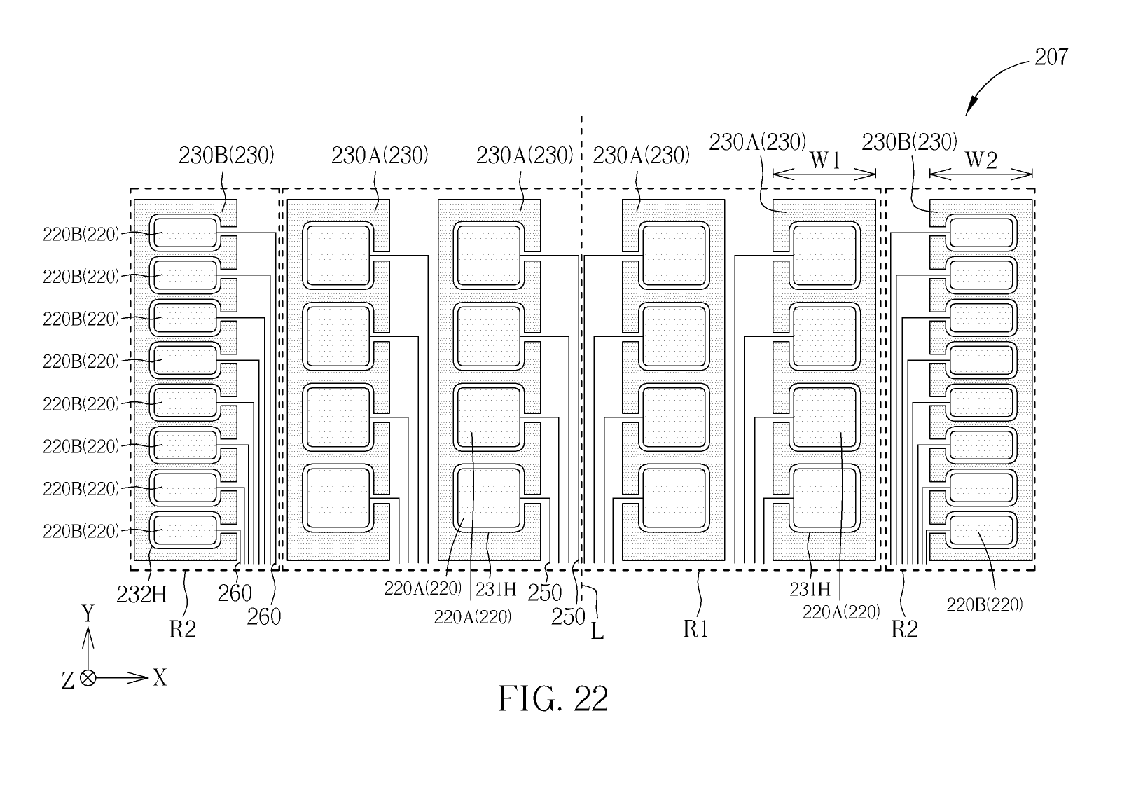

As shown in FIG. 22, a touch panel 207 is provided in the thirteenth preferred embodiment of the present invention. The difference between the touch panel 207 in this embodiment and the touch panel in the seventh preferred embodiment mentioned above is that, in the touch panel 207, the first sub-electrodes 220A, the third sub-electrodes 230A and the first traces 250 have a shape with mirror symmetry symmetrical to the straight symmetry line L. The second sub-electrodes 220B, the fourth sub-electrode 230B and the second traces 260 have a shape with mirror symmetry symmetrical to the straight symmetry line L. Additionally, the first traces 250 and the second traces 260 are disposed on positions closer to the straight symmetry line L, compared with the corresponding first sub-electrodes 220A and the corresponding second sub-electrodes 220B.

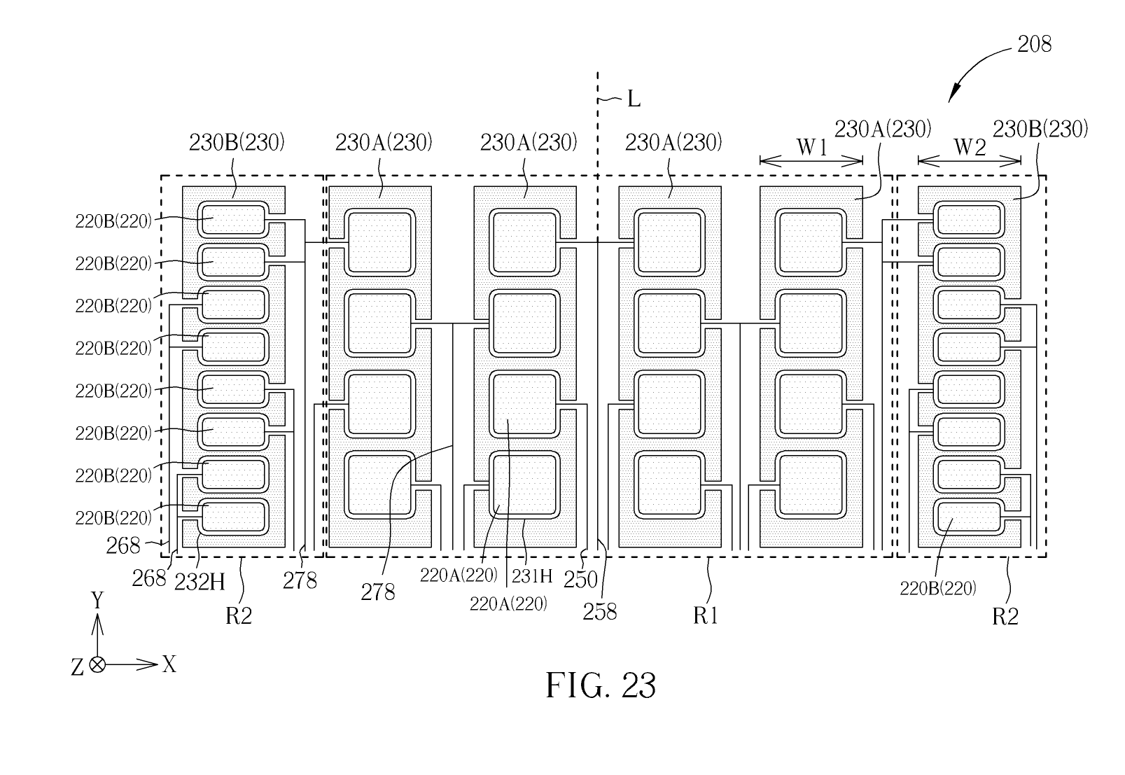

As shown in FIG. 23, a touch panel 208 is provided in the fourteenth preferred embodiment of the present invention. The difference between the touch panel 208 in this embodiment and the touch panel in the seventh preferred embodiment mentioned above is that the touch panel 208 further includes a plurality of first traces 258, a plurality of second traces 268 and at least one third trace 278. Each of the first traces 258 is electrically connected to two first sub-electrodes 220A corresponding to different third sub-electrodes 230A. Each of the second traces 268 is electrically connected to two of the second sub-electrodes 220B. The third trace 278 is electrically connected to one of the first sub-electrodes 220A and two of the second sub-electrodes 220B. Additionally, the first sub-electrodes 220A, the second sub-electrodes 220B, the third sub-electrodes 230A, the fourth sub-electrodes 230B, the first traces 258, the second traces 268 and the third traces 278 have a shape with mirror symmetry symmetrical to the straight symmetry line L so as to reduce the amount of the traces and the spacing between each third sub-electrode 230A and each fourth sub-electrode 230B.

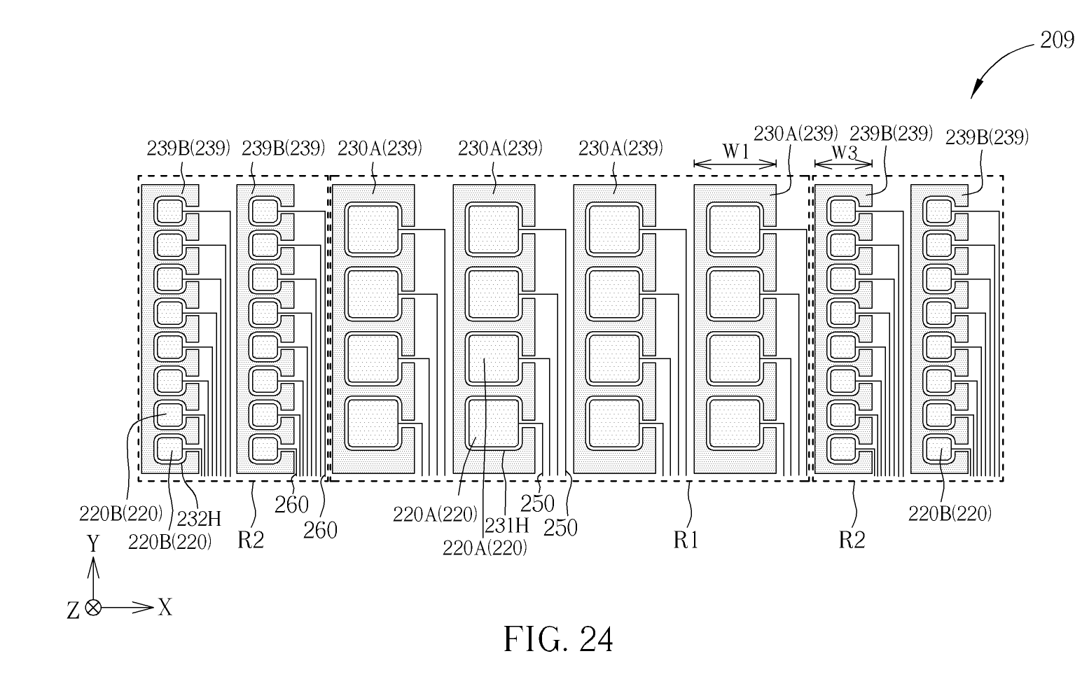

As shown in FIG. 24, a touch panel 209 is provided in the fifteenth preferred embodiment of the present invention. The difference between the touch panel 209 in this embodiment and the touch panel in the seventh preferred embodiment mentioned above is that the touch panel 209 includes the first electrode 220 and a second electrode 239. The second electrode 239 includes a plurality of third sub-electrodes 230A and a plurality of fourth sub-electrodes 239B. The fourth sub-electrodes 239B are disposed in the peripheral region R2. Each of the fourth sub-electrodes 239B includes a plurality of second hollow regions 232H aligned along the column direction Y, and the second sub-electrodes 220B are disposed in the second hollow regions 232H. It is worth noting that, in this embodiment, a width W3 of each fourth sub-electrode 239B along the row direction X is preferably smaller than the width W1 of each third sub-electrode 230A along the row direction X so as to increase the amount of the corresponding second sub-electrodes 220B in the peripheral region R2 and increase the pattern density of the second sub-electrodes 220B. The touch identification performance in the peripheral region R2 may be enhanced and the linearity of touch operations in the peripheral region R2 may be improved accordingly.

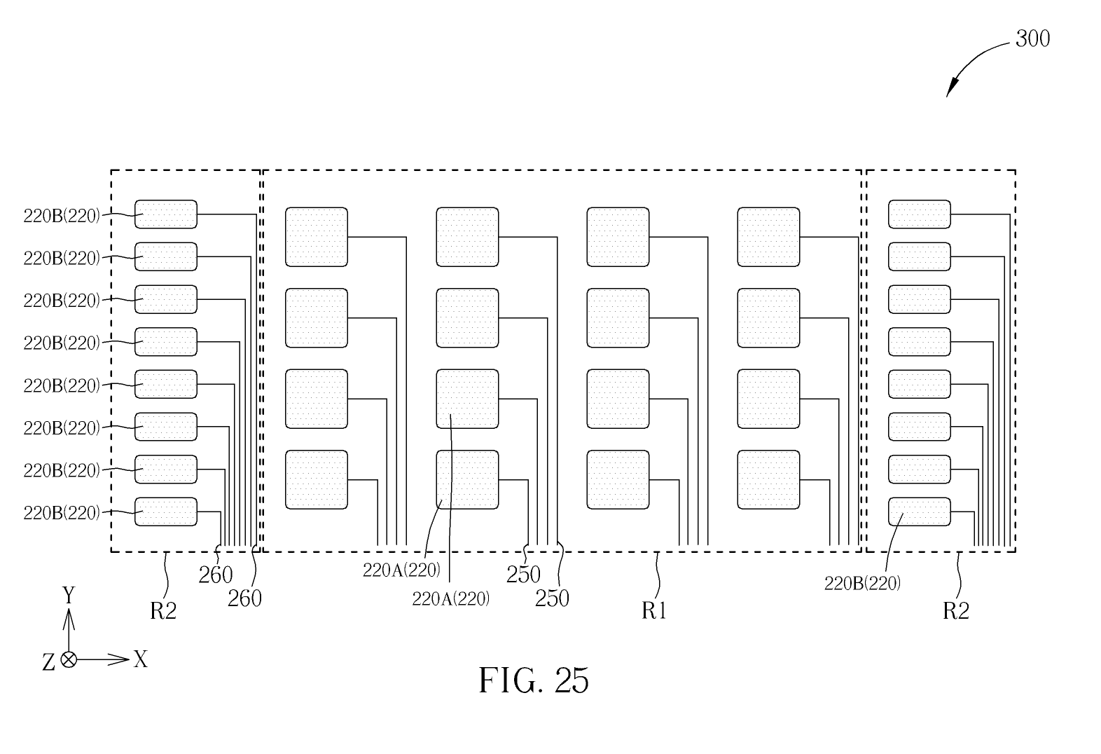

As shown in FIG. 25, a touch panel 300 is provided in the sixteenth preferred embodiment of the present invention. The difference between the touch panel 300 in this embodiment and the touch panel in the seventh preferred embodiment mentioned above is that the touch panel 300 only includes the first electrode 220. The touch panel 300 may be used to perform a self-capacitive touch sensing operation, but not limited thereto. When a touch object such as a finger touches the touch the center region R1 and the peripheral region R2 in the touch panel 300 by an identical touch area respectively, coupled electrical capacitance generated from the second sub-electrodes 220B in the peripheral region R2 may be larger than or equal to coupled electrical capacitance generated from the first sub-electrodes 220A in the center region R1 because the pattern density of the second sub-electrodes 220B in the peripheral region R2 is higher than the pattern density of the first sub-electrodes 220A in the center region R1. The touch identification performance in the peripheral region R2 may be enhanced and the linearity of touch operations in the peripheral region R2 may be improved accordingly.

To summarize the above descriptions, in the touch panel of the present invention, the pattern density of the sub-electrodes in the peripheral region are designed to be higher than the pattern density of the sub-electrodes in the center region, and the coupled capacitance effect generated between the sub-electrodes in the peripheral region may then become larger than or equal to the coupled capacitance effect generated between the sub-electrodes in the center region. Therefore, even if some of the sub-electrodes may be incomplete in shape because of cutting at the edge of the touch panel, the electrical capacitance effect generated from the sub-electrodes at the edge may still be similar to the electrical capacitance effect generated in the center region R1. The touch identification performance in the peripheral region may be enhanced and the linearity of touch operations in the peripheral region may be improved accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, having a center region and a peripheral region disposed on at least one side of the center region, the touch panel comprising:
a first electrode, comprising:
a plurality of first sub-electrodes, disposed in the center region; and
a plurality of second sub-electrodes, disposed in the peripheral region, wherein a pattern density of the second sub-electrodes in the peripheral region is higher than a pattern density of the first sub-electrodes in the center region.

2. The touch panel of claim 1, wherein an area of each first sub-electrode is larger than an area of each second sub-electrode.

3. The touch panel of claim 1, further comprising:
a second electrode, electrically insulated from the first electrode, the second electrode comprising:
a plurality of third sub-electrodes, disposed in the center region, wherein a location of each third sub-electrode in the center region is different from a location of each first sub-electrode, and each third sub-electrode is electrically insulated from each first sub-electrode; and
a plurality of fourth sub-electrodes, disposed in the peripheral region, wherein a location of each fourth sub-electrode in the peripheral region is different from a location of each second sub-electrode, and each fourth sub-electrode is electrically insulated from each second sub-electrode.

4. The touch panel of claim 3, wherein fringe electrical capacitance formed between the second sub-electrodes and the fourth sub-electrodes within a unit area in the peripheral region is larger than fringe electrical capacitance formed between the first sub-electrodes and the third sub-electrodes within an identical unit area in the center region.

5. The touch panel of claim 3, wherein each first sub-electrode and each third sub-electrode are alternately disposed in the center region, and each second sub-electrode and each fourth sub-electrode are alternately disposed in the peripheral region.

6. The touch panel of claim 3, wherein a pattern density of the fourth sub-electrodes in the peripheral region is higher than a pattern density of the third sub-electrodes in the center region.

7. The touch panel of claim 3, wherein an area of each third sub-electrode is larger than an area of each fourth sub-electrode.

8. The touch panel of claim 3, wherein each of the first sub-electrodes is disposed adjacently to and electrically connected to at least one of the first sub-electrodes or one of the second sub-electrodes along a row direction, and each of the third sub-electrodes is disposed adjacently to and electrically connected to at least one of the third sub-electrodes or one of the fourth sub-electrodes along a column direction.

9. The touch panel of claim 8, wherein at least one of the first sub-electrodes and at least apart of the second sub-electrodes are electrically connected in parallel, and at least one of the third sub-electrodes and at least apart of the fourth sub-electrodes are electrically connected in parallel.

10. The touch panel of claim 8, further comprising a plurality of first connection lines and a plurality of second connection lines, wherein the first sub-electrodes and the second sub-electrodes are electrically connected to one another along the row direction via the first connection lines, and the third sub-electrodes and the fourth sub-electrodes are electrically connected to one another along the column direction via the second connection lines.

11. The touch panel of claim 10, further comprising an insulation layer, disposed between each first connection line and each second connection line so as to electrically insulate the first connection lines from the second connection lines.

12. The touch panel of claim 11, further comprising a first substrate, wherein the first electrode, the second electrode, the first connection lines, the second connection lines and the insulation layer are disposed on the first substrate, and at least one of the first connection lines is disposed between the insulation layer and the first substrate.

13. The touch panel of claim 12, wherein at least one of the second connection lines is disposed between the insulation layer and the first substrate.

14. The touch panel of claim 3, further comprising a first substrate and a second substrate disposed correspondingly to the first substrate, wherein the first electrode is disposed on the first substrate, and the second electrode is disposed on the second substrate.

15. The touch panel of claim 3, wherein at least one of the third sub-electrodes comprises a notch surrounding the second sub-electrode adjacent to the third sub-electrode.

16. The touch panel of claim 3, wherein each of the third sub-electrodes comprises a plurality of first hollow regions aligned along a column direction, each of the fourth sub-electrodes comprises a plurality of second hollow region aligned along the column direction, the first sub-electrodes are disposed in the first hollow regions, and the second sub-electrodes are disposed in the second hollow regions.

17. The touch panel of claim 16, wherein a width of each third sub-electrode along a row direction is equal to a width of each fourth sub-electrode along the row direction.

18. The touch panel of claim 16, wherein a width of each fourth sub-electrode along a row direction is smaller than a width of each third sub-electrode along the row direction.

19. The touch panel of claim 16, further comprising a plurality of first traces and a plurality of second traces, wherein each of the first traces is electrically connected to at least one of the first sub-electrodes, and each of the second traces is electrically connected to at least one of the second sub-electrodes.

20. The touch panel of claim 19, wherein the first sub-electrodes, the third sub-electrodes and the first traces have a shape with mirror symmetry symmetrical to a straight symmetry line, and the second sub-electrodes, the fourth sub-electrode and the second traces have a shape with mirror symmetry symmetrical to the straight symmetry line.

21. The touch panel of claim 16, further comprising at least one third trace, wherein the third trace is electrically connected to at least one of the first sub-electrodes and at least one of the second sub-electrodes.

22. The touch panel of claim 16, wherein the fourth sub-electrodes are aligned along the column direction in the peripheral region.

23. The touch panel of claim 12, wherein the first substrate comprises a glass substrate, a plastic substrate, a glass film, a plastic film, a cover substrate or a substrate of a display device.

24. The touch panel of claim 23, wherein a decoration layer is disposed on at least one side of the cover substrate.

25. The touch panel of claim 23, wherein the substrate of the display device comprises a color filter substrate of a liquid crystal display device or an encapsulation substrate of an organic light emitting display device.

26. The touch panel of claim 14, wherein at least one of the first substrate and the second substrate comprises a glass substrate, a plastic substrate, a glass film, a plastic film, a cover substrate or a substrate of a display device.

27. The touch panel of claim 26, wherein a decoration layer is disposed on at least one side of the cover substrate.

28. The touch panel of claim 26, wherein the substrate of the display device comprises a color filter substrate of a liquid crystal display device or an encapsulation substrate of an organic light emitting display device.
